(19) United States
(12) Patent Application Publication
(10) Pub. No.: US 2023/0299479 A1
(43) Pub. Date: Sep. 21, 2023

(54) CONTROLLING THE FAR FIELD RADIATION PATTERN OF A METASURFACE ANTENNA USING CONVEX OPTIMIZATION

(71) Applicant: Kymeta Corporation, Redmond, WA (US)

(72) Inventors: Chris Eylander, Seattle, WA (US); Hamidreza Chalabi, Ann Arbor, MI (US); Mohsen Sazegar, Kirkland, WA (US)

(21) Appl. No.: 18/121,936

(22) Filed: Mar. 15, 2023

Related U.S. Application Data
(60) Provisional application No. 63/320,608, filed on Mar. 16, 2022.

(51) Int. Cl. H01Q 3/36; H01Q 3/28; H01Q 9/16; H01Q 15/24

(52) U.S. Cl. CPC H01Q 3/36; H01Q 3/28; H01Q 9/16; H01Q 15/24

(57) ABSTRACT

A method and apparatus for controlling the far field radiation pattern of a metasurface antenna using convex optimization are disclosed. In some embodiments, a method for controlling a metasurface antenna having antenna elements comprises: determining a desired phase and amplitude for each of the antenna elements in order to achieve a desired far field radiation pattern using convex optimization; and controlling radio frequency (RF) radiating antenna elements based on the desired phase and amplitude using one or more control parameters to perform beam forming.

### RELATED APPLICATION

The present application is a non-provisional application of and claims the benefit of U.S. Provisional Patent Application No. 63/320,608, filed Mar. 16, 2022, and entitled “CONTROLLING THE FAR FIELD RADIATION PATTERN OF THE METASURFACE ANTENNA USING CONVEX OPTIMIZATION”, which is incorporated by reference in its entirety.

### FIELD OF THE DISCLOSURE

Embodiments disclosed herein are related to wireless communication; more particularly, embodiments disclosed herein relate to the use of convex optimization to generate modulation states to control a holographic beamforming antenna.

### BACKGROUND

Metasurface antennas have recently emerged as a new technology for generating steered, directive beams from a lightweight, low-cost, and planar physical platform. Such metasurface antennas have been recently used in several applications, such as, for example, satellite communication.

Metasurface antennas may comprise metamaterial antenna elements that can selectively couple energy from a feed wave to produce beams that may be controlled for use in communication. These antennas can achieve comparable performance to phased array antennas from an inexpensive and easy-to-manufacture hardware platform. By tuning the constituent metamaterial elements' characteristics, a hologram at the aperture plane can be achieved, in which the waveguide mode acts as the reference wave and the collection of tuned elements form the hologram. The overall radiation from these holographic antennas can thereby be modulated to form arbitrary patterns by use of electronic tuning. These antennas can achieve comparable performance to phased array antennas from an inexpensive and easy-to-manufacture hardware platform.

By using simpler antenna elements as compared to phased arrays, the operation of a metasurface is easier and faster. These elements, however, do not exhibit the same level of control as is achievable with phase shifters and amplifiers, common to phased array architectures. To regain some of the control that is possible with phased array elements, metasurface elements are typically spaced closer together to more finely sample the guided wave. In further contrast to phased array antennas, however, tuning metamaterial elements does not provide independent control of both the magnitude and phase of each individual element in the array. Instead, tuning a metamaterial unit cell results in a shift in the resonant frequency, which shifts both the magnitude and phase response with only one control knob. As a result, attempting to create arbitrary magnitude or phase patterns within a metasurface antenna can yield undesirable results. The reason that creating arbitrary magnitude or phase patterns does not work as intended can be traced back to the coupled nature of the magnitude and phase of the resonant elements in a metasurface antenna. Considering a phase pattern, when tuning an antenna element to a certain phase value, the magnitude of the element becomes correspondingly shifted. This arbitrary shift can lead to unwanted periodic behavior or to low radiation efficiency. In the same manner, similar side effects of phase artifacts result when attempting to create a magnitude pattern. These problems do not exist in traditional phased array systems because amplifiers and phase shifters can directly compensate for any such unwanted artifacts.

One method of modulating individual elements in a metasurface antenna element is to turn some elements “on” while others are kept “off”. This is referred to as binary modulation. Another method that is used is referred to as greyshade modulation in which antenna elements have more states than simply one “on” state and an “off” state.

### SUMMARY

A method and apparatus for controlling the far field radiation pattern of a metasurface antenna using convex optimization are disclosed. In some embodiments, a method for controlling a metasurface antenna having antenna elements comprises determining a desired phase and amplitude for each of the antenna elements to achieve a desired far field radiation pattern using convex optimization; and controlling radio frequency (RF) radiating antenna elements based on the desired phase and amplitude using one or more control parameters to perform beam forming.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded view of some embodiments of a flat-panel antenna.

FIG. 2 illustrates an example of a communication system that includes one or more antennas described herein.

FIG. 3 shows a typical antenna along with several directions.

FIG. 4 illustrates some embodiments of a data flow diagram depicting a process for generating modulation for an antenna.

FIG. 5A illustrates some embodiments of a high-level system diagram.

FIG. 5B illustrates the interference feedback they received based on a generated pattern.

FIG. 6A is a data flow diagram of one embodiment of a process for controlling an antenna.

FIG. 6B is a flow diagram of one embodiment of a modulation process for controlling an antenna.

FIG. 7A is a flow diagram of some embodiments of a process for controlling an antenna.

FIG. 7B is a flow diagram of some other embodiments of a process for controlling an antenna.

FIG. 8 is one embodiment of a computer system that may be used to support the systems and operations discussed herein, including performance of a convex optimization solver for solving the convex optimization problem.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, to avoid obscuring the present disclosure.

Embodiments described herein include an antenna having a reduced number of routing lines. In some embodiments, the antenna is part of a satellite user terminal. In some embodiments, the antenna is a metamaterial antenna with radio-frequency (RF) radiating antenna elements such as, for example, described below. In some embodiments, the antenna includes drive circuitry for driving the antenna elements.

An antenna and method for controlling the same are disclosed. In some embodiments the antenna is controlled using modulation generated using convex optimization. In some embodiments, the modulation achieves arbitrary, desired, radiation patterns from a metasurface antenna. More specifically, modulation includes one or more main beams in one or more directions with one or more nulls in other directions.

The following disclosure discusses examples of antenna embodiments followed by a description of techniques for generating a modulation (e.g., pattern) for antenna elements of an antenna using convex optimization.

### Examples of Antenna Embodiments

The techniques described herein may be used with a variety of flat panel satellite antennas. Embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Pat. No. 11,489,266, entitled “Metasurface Antennas Manufactured with Mass Transfer Technologies,” issued Nov. 1, 2022. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

In some embodiments, the antenna aperture having the one or more arrays of antenna elements is comprised of multiple segments that are coupled together. In some embodiments, when coupled together, the combination of the segments form groups of antenna elements (e.g., closed concentric rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

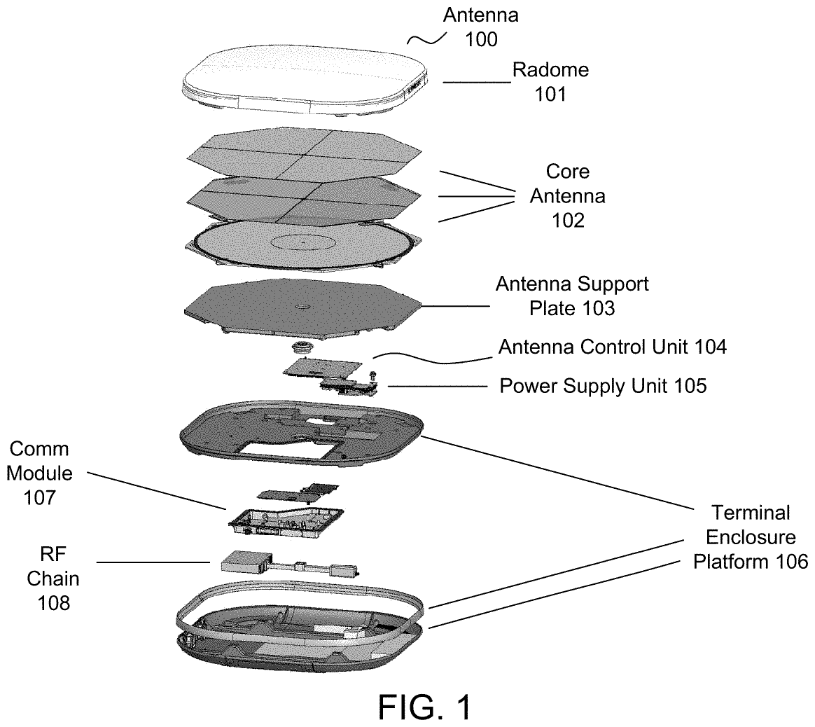

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation f=1/2π\sqrt{LC} where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018, or in U.S. Pat. No. 11,489,266, entitled “Metasurface Antennas Manufactured with Mass Transfer Technologies,” issued Nov. 1, 2022. In some embodiments, the cylindrical wave feed feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

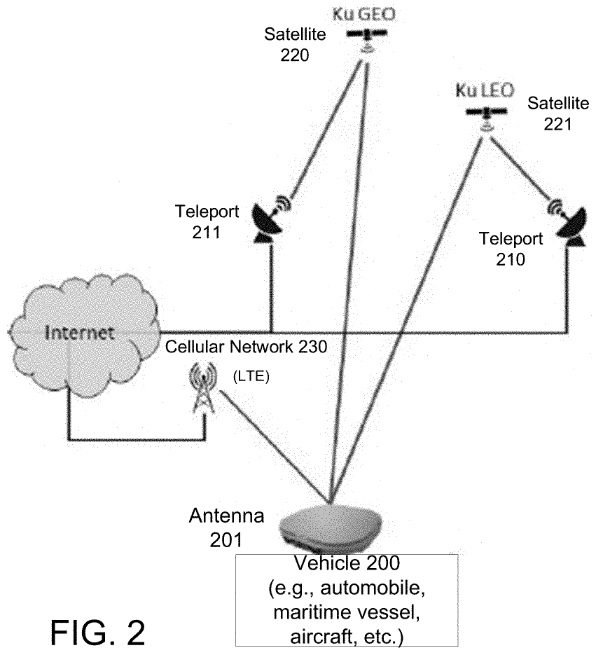

FIG. 2 illustrates an example of a communication system that includes one or more antennas described herein. Referring to FIG. 2, vehicle 200 includes an antenna 201. In some embodiments, antenna 201 comprises antenna 100 of FIG. 1.

In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 can communicate with one or more communication infrastructures (e.g., satellite, cellular, networks (e.g., the Internet), etc.). For example, in some embodiments, antenna 201 can communicate with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. patent Ser. No. 16/750,439, entitled “Multiple Aspects of Communication in a Diverse Communication Network”, and filed Jan. 23, 2020.

In some embodiments, to facilitate communication with various satellites, antenna 201 performs dynamic beam steering. In such a case, antenna 201 can dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

Thus, the antennas described herein may be part of a satellite terminal that enables ubiquitous communications and multiple different communication connections.

In some embodiments, antenna 201 comprises a metasurface RF antenna having multiple RF radiating antenna elements that are tuned to desired frequencies using RF antenna element drive circuitry. The drive circuitry can include a drive transistor (e.g., a thin film transistor (TFT) (e.g., CMOS, NMOS, etc.), low or high temperature polysilicon transistor, memristor, etc.), a Microelectromechanical systems (MEMS) circuit, or other circuit for driving a voltage to an RF radiating antenna element. In some embodiments, the drive circuitry comprises an active-matrix drive. In some embodiments, the frequency of each antenna element is controlled by an applied voltage. In some embodiments, this applied voltage is also stored in each antenna element (pixel circuit) until the next voltage writing cycle.

### Controlling a Far Field Radiation Pattern of the Metasurface Antenna

Embodiments disclosed herein include techniques that allow control of the far field radiation pattern of a metamaterial antenna in both receive (RX) or transmit (TX) modes. In some embodiments, the antenna comprises a radiating metasurface having RF radiating antenna elements and a feeding device that can feed the metasurface with one or more feed waves. Using convex optimization, a determination can be made as to what state in which these antenna elements can achieve a desired far field radiation pattern. Specifically, the states of the antenna elements are determined to achieve nulls at specific directions in the radiation pattern while keeping the main beam pointed at the target direction. Null forcing the far field pattern at desired directions can reduce interference caused by the received signals from undesired satellites. In some embodiments, the null forcing techniques presented herein provide the nulling of the undesired received or transmitted signals with arbitrary (selectable) polarization (e.g., linear polarization, circular polarization, etc.).

In some embodiments, techniques described herein determine the states of the antenna elements of the metasurface on the antenna, and using the state information, the antenna can induce zeros (or near zeros) in selected directions in the far field radiation pattern of the antenna. In some embodiments, these selected directions are directions from which interference is being generated. In some embodiments, the directions of the sources of interference can be identified by sweeping one or more areas of the desired far field associated with the one or more main beams to be used or being used by the antenna for transmit and/or receive. Note that these operations can be achieved simultaneously. In addition, or instead, in some embodiments, the selected directions are directions in the far field through which a null would reduce interference that is being generated. Note that there can be one or several directions that where the far field radiation is controlled to tend toward zero.

Nulls can be located anywhere in the far field pattern. For example, in some embodiments, nulls are located within 20 degrees of the main beam causing >20 dB additional suppression of receiving signals with the antenna. A null can be put in a TX modulation pattern and a RX modulation pattern simultaneously because the Tx and Rx elements are separate sets. In some embodiments, as the number of nulls increases, the overall effect of each individual null on interference reduction can be reduced.

In some embodiments, the techniques described herein determine the modulations to be applied to antenna elements to create one or more nulls at specific angles while keeping the gain at the beam angle to be least degraded (e.g., 0.2 dB). In some embodiments, use of the techniques results in nulling the far field pattern at desired directions with minimal gain impact, for example, impacting the main beam gain less than 0.5 dB for a null location outside the extent of 1^{st} side lobes. If the null is desired to move within the extents of the 1^{st} sidelobes of the main beam, the main beam gain can be impacted more as the null begins to collide with the main beam. That is, the techniques according to some embodiments allow for nulling the far field pattern of the antenna in desired directions to reduce the interference caused by the signals coming from (e.g., signals being received from certain directions, etc.) or going to directions (e.g., signals being transmitted in certain directions, etc.). In some embodiments, the method can be used in either the receive or transmit modes.

If the real and imaginary parts of the modulations of the antenna elements are shown with wᵣ and wᵢ, respectively, the concatenation of them can be defined with w as:

w=[wᵣ,wᵢ]

One problem is to find these modulations to have a desired far field pattern. For a determined direction represented by the spherical coordinate angles theta and phi, the generated field at theta and phi direction corresponding to the input wave wᵢₙ can be defined as:

Aₜₕₑₜₐ=wᵢₙEₜₕₑₜₐ Exp(jk_{f}(x Sin(theta)Cos(phi)+y Sin(theta)Sin(phi)))

Aₚₕᵢ=wᵢₙEₚₕᵢ Exp(jk_{f}(x Sin(theta)Cos(phi)+y Sin(theta)Sin(phi)))

In these equations, x and y represent cartesian coordinates of the antenna elements and k_{f} is the free space wave vector.

For a specific desired polarization represented by the angle lpa and phase offset of ϕ_{offset}, the following matrices for the co-polarization (copol) and cross polarization (xpol) components can be defined:

$${A}_{copol} = {A}_{theta} Cos ( lpa ) + Exp ( - j {ϕ}_{offset} ) {A}_{phi} Sin ( lpa )$$

$${A}_{xpol} = {A}_{theta} Cos ( lpa + \frac{pi}{2} ) + Exp ( - j {ϕ}_{offset} ) {A}_{phi} Sin ( lpa + \frac{pi}{2} )$$

$${M}_{copol} = [ [ Re ( {A}_{copol} ) , - Im ( {A}_{copol} ) ] ; [ Im ( {A}_{copol} ) , Re ( {A}_{copol} ) ] ]$$

$${M}_{xpol} = [ [ Re ( {A}_{xpol} ) , - Im ( {A}_{xpol} ) ] ; [ Im ( {A}_{xpol} ) , Re ( {A}_{xpol} ) ] ] ,$$

In terms of these quantities, the far field electric field components can be required to satisfy specific criteria. Examples of the criteria are described in more detail below.

In some embodiments, to have minimum cross polarization, the following is minimized:

target=|w·Mₓₚₒₗ|²

subject to the following inequality constraints:

w·M_{copol}=[1,0]

|wᵢ(n)²+wᵣ(n)²|≤1 for each antenna element n

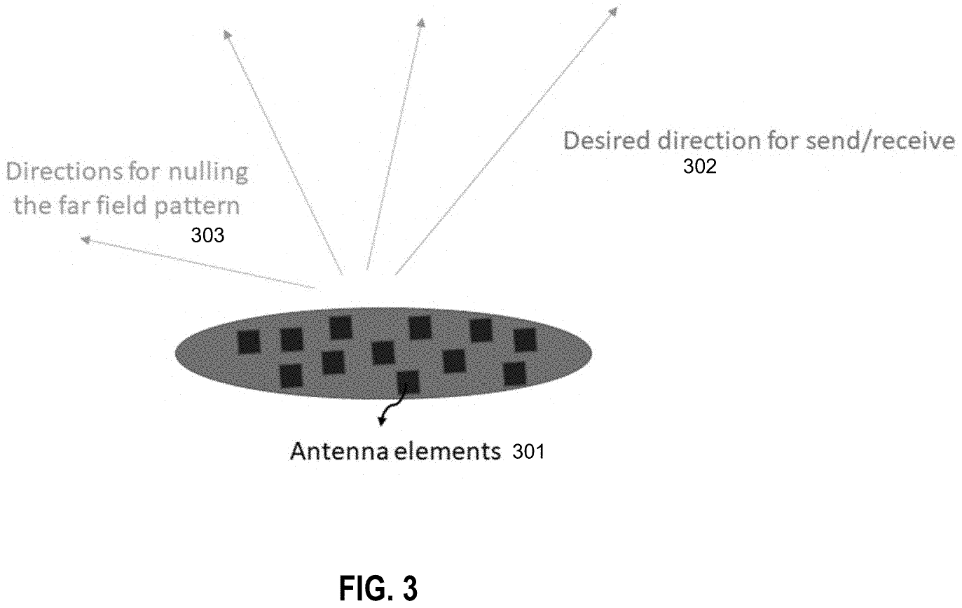

If nulls are desired at specific directions (e.g., see FIG. 3), they can be explicitly added to the constraints to be used in the convex optimization problem by similarly defining the corresponding matrix as Mₙᵤₗₗ, and requiring that:

|w·Mₙᵤₗₗ|²≤λ

In some embodiments, the matrix (or array) can be viewed as a list of constraints, like, for example,

[
w.M1 < lam1; theta1 null < 10 dB
.
.
w.M2 < lam2; theta2 null < 14 dB
w.MN < lamN; thetaN null < N dB
]
.

An increase of the number of directions at which the creation of a null is desired causes an increase in the number of null constraints accordingly. In some embodiments, there is one matrix per null direction.

In some embodiments, after finding the ideal modulations needed for each element by solving the above optimization problem, which is a convex one, the best available modulations that can be provided to the elements using the Euclidean mapping can be determined. For more information on Euclidean modulation and the use of Euclidean mapping, see U.S. Pat. No. 10,686,636, entitled “Restricted Euclidean Modulation”, issued Jun. 16, 2020, and U.S. Pat. No. 11,018,912, entitled “Restricted Euclidean Modulation”, issued May 25, 2021.

FIG. 3 shows a typical antenna along with several directions. In some embodiments, the antenna can transmit (TX) and/or receive (RX) in a desired direction, while having a far field pattern for that antenna that goes toward zero along one or more directions where the sending and/or receiving of any signals is not desired. In some embodiments, the directions where the sending and/or receiving of any signals is not desired could be one, two, three or more directions.

Referring to FIG. 3, antenna elements 301 generate a far field radiation pattern. In some embodiments, the far field radiation pattern includes one or more transmit and/or receive beams in desired directions, such as the beam in direction 302. The far field radiation pattern also includes directions of nulls for the far field radiation pattern. In some embodiments, there is one direction for nulling the far field pattern. In some other embodiments, there are multiple directions for nulling the far field pattern, such as directions 303.

In some embodiments, the techniques described herein create nulls at specific angles while keeping the gain at the beam angle to be least degraded (e.g., 0.2 dB). In some embodiments, these techniques enable reducing the interferences from signals coming from one or more undesired directions without sacrificing antenna gain significantly. That is, in some embodiments, the techniques allow for nulling the far field pattern of the antenna in one or more desired directions to reduce the interference caused by the signals coming/going from/to specific directions.

Thus, using null forcing techniques according to embodiments of the present disclosure provides for reducing interference from unwanted signals. In turn, this provides the realization of a more reliable and unbreakable connection. The techniques disclosed herein make it possible that if a source attempts to send corrupt signals from an unwanted direction, an antenna can take actions to prevent itself from being affected by such signals, particularly when performing the null forcing operation described herein using a metamaterial-based antenna with sub-wavelength antenna elements.

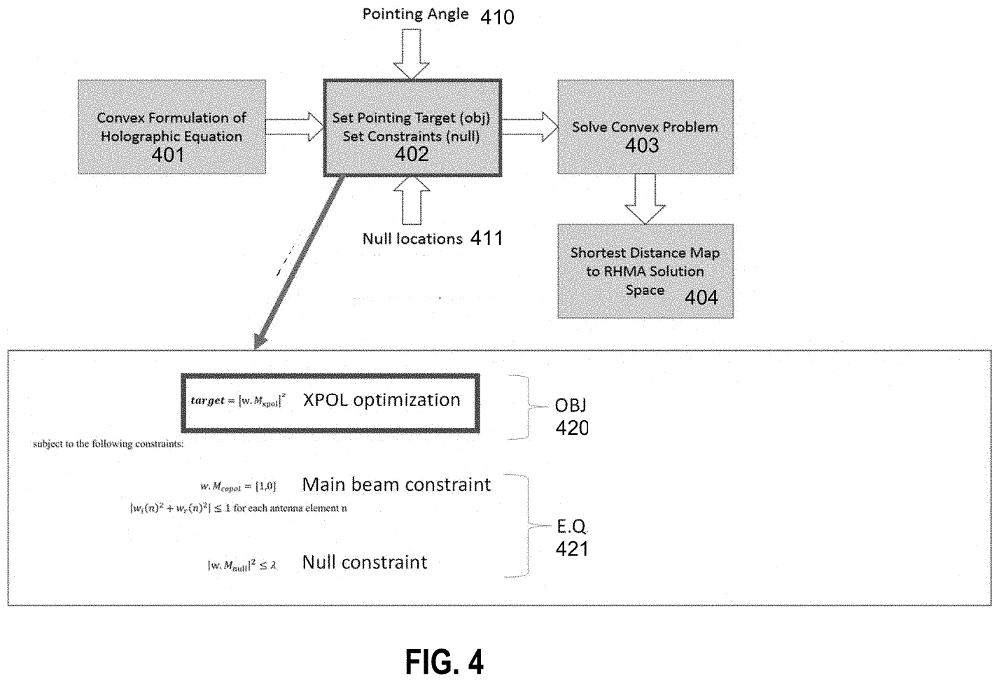

FIG. 4 illustrates some embodiments of a data flow diagram depicting a process for generating modulation for an antenna, such as antennas described above. Referring to FIG. 4, the process begins by generating a convex formulation of the holographic equation for (processing block 401). The far field pattern can be expressed with an array factor calculation which is linear and therefore convex; an example is shown in 0057. The constraints imposed by the element state set of the metasurface must also be convex. The state domain must be chosen carefully and defined in a way such that the outcome of the convex optimization problem yields solutions that are close to the achievable states that the metasurface exhibits.

Processing block 402 receives the complex formulation of the holographic equation along with pointing angle 410 and null locations 411. Pointing angle 410 represents a direction of a desired beam (e.g., the main beam), and null locations 411 represent the directions of one or more of nulls. In some embodiments, point angle 410 is represented using phi and theta. In some embodiments, each of null locations 411 is represented by phi, theta, and lambda.

In response to these inputs, processing block 402 sets an objection function and one or more constraints for a convex optimization problem to be solved by a convex optimization solver. In some embodiments, the objection function is a pointing target and constraints are based on the one or more nulls. As discussed above, the objection function is the minimization of cross polarization:

target=|w·Mₓₚₒₗ|²

In some embodiments, use of the XPOL in the objection function is key in that if this is not done, then the XPOL of the main beam grows as the beam is scanned off.

In some embodiments, the objection function is subject to the following constraints:

w·M_{copol}=[1,0],

|wᵢ(n)²+wᵣ(n)²|≤1 for each antenna element n,

which is a main beam constraint,

|w·Mₙᵤₗₗ|²≤λ

which is a null constraint.

The complex optimization solver 403 solves the convex optimization problem and generates a desired modulation. In some embodiments, a well-known, commercially available convex optimization solver (e.g., Interior points or Barrier methods, etc.) is used to solve the convex optimization problem with the pointing target and constraints. In some embodiments, the solution is a desired modulation to achieve the desired main beam(s) and desired one or more nulls.

In some embodiments, modulation generator 404 generates the actual modulation that is used to control the antenna elements of the antenna. In some embodiments, modulation generator 404 generates a modulation that is achievable by the antenna. In some embodiments, the achievable modulation is generated using a shortest distance map that maps the desired modulation to the achievable modulation for a reconfigurable holographic metamaterial (RHMA). In some embodiments, modulation generator 404 comprises Euclidean modulation logic for determining the shortest distance map to map the desired modulation to the achievable modulation.

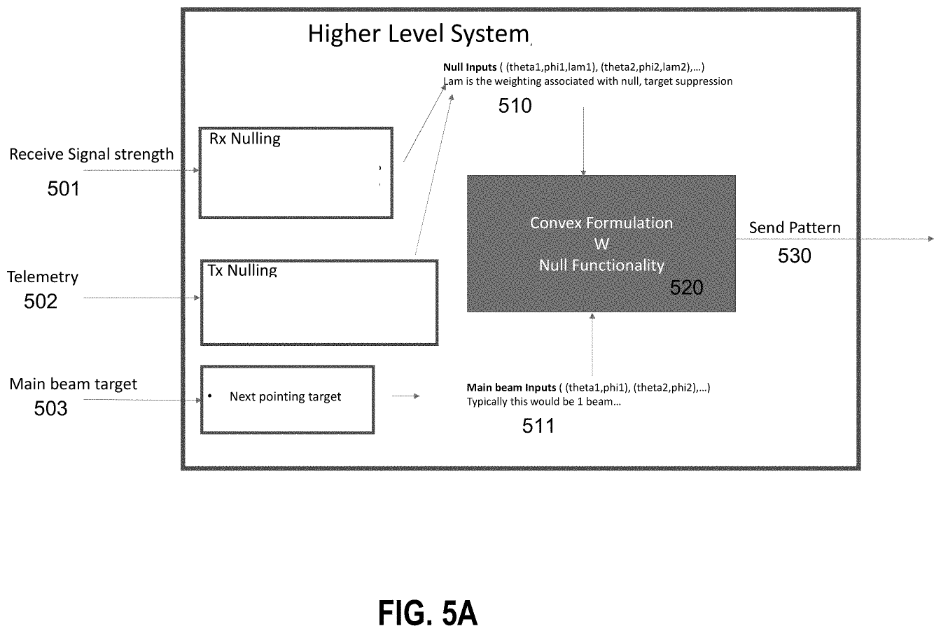

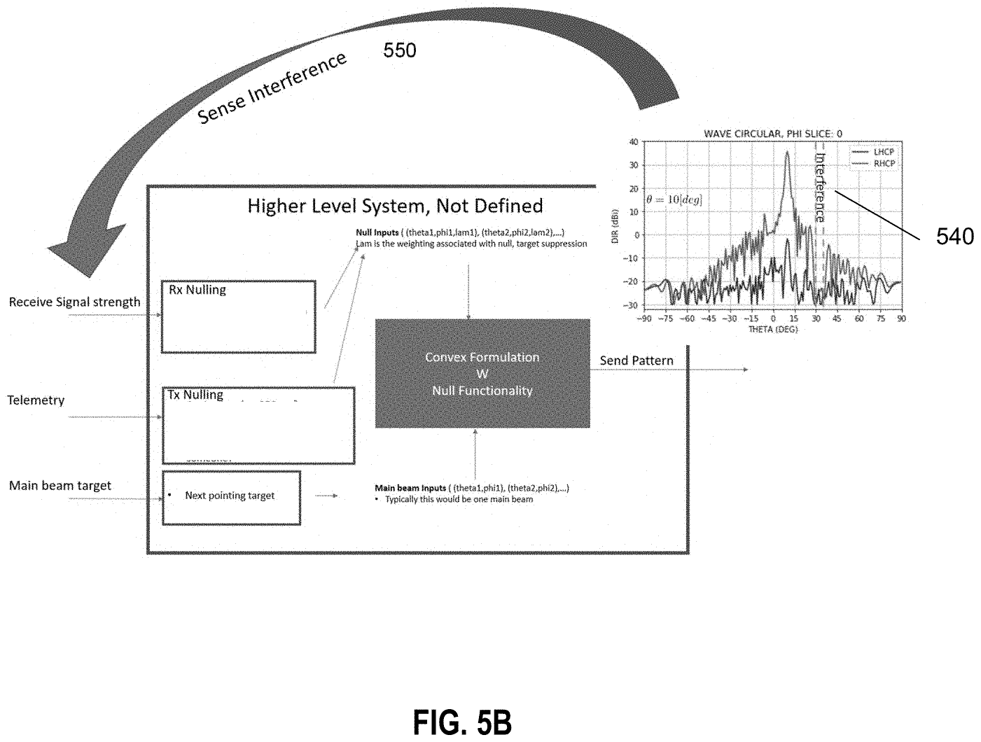

FIG. 5A illustrates some embodiments of a high-level system diagram. The high-level system diagram performs the convex optimization operation using a convex formulation with null functionality described above with respect to the data flow diagram of FIG. 4.

Referring to FIG. 5A, the system receives the signal strength 501, telemetry 502 and an indication of main beam target 503. Main beam target 503 represents the next pointing target and is input into the convex formulation processing circuitry 520 (e.g., one or more processors, etc.) as a main beam input. As discussed above, in some embodiments, there can be more than one main beam, and each main beam input is specified by theta and phi. In some embodiments, main beam target 503 is one beam. The one beam can be a transmit or receive beam. In some other embodiments, there may be multiple main beam inputs such as for example multiple receive beams, multiple transmit beams, and/or a combination of receive and transmit beams (e.g., a receive beam with a transmit beam, etc.).

In some embodiments, null inputs 510 for the convex formulation processing circuitry 520 are also specified by the theta and phi as well as a weighting associated with the null and the target suppression. If larger suppression is desired, the weighting is made larger. At some point, the large suppression may come at the expense of main beam gain. In some embodiments, weighting can be swept and the main beam objectives or constraints can also be swept to determine what is optimal or achieve better results with respect to target suppression.

In some embodiments, null inputs 510 are identified based on the interference to the desired far field pattern that it being generating. In some embodiments, the interference may come from one or multiple sources. For example, the interference may come from one or more other satellites transmitting signals. Note that interference sources other than from satellites may be causing interference to the far field pattern desired for use by the antenna.

Null inputs 510 can be to null interference for signals being transmitted or received and the result of the system determining that nulling should occurring during transmit (TX) or receive (RX), respectively. For example, the system can determine the sources and locations of interference, as well as determining if previously identified null locations may no longer be source of interference to the antenna (e.g., as the antenna moves, the interference caused by one satellite can change), to determine one or more nulls during RX. For another example, if during transmit, the antenna is pointed near the GEO arc, there may be a crowded sky and a need to provide a nulling input to avoid interfering with an adjacent satellite. Furthermore, in some embodiments a null can be specified during the transmit operation to reduce or minimize power near another party or satellite to prevent interfering with them.

With null inputs 510 and main beam inputs 511, convex formulation circuitry 520 generates a modulation pattern 530 that is sent to the antenna as the control pattern to control the RF radiating antenna elements of an antenna (e.g., a metasurface antenna, etc.).

In some embodiments, the modulation generation process is performed to identify interfering sources and uses the identified interference sources as feedback into the convex optimization process to improve the results of the convex optimization. For example, in some embodiments, the convex optimization process may sweep through many locations to identify interference locations. The data that is obtained as part of the sweep is fed back to convex formulation circuitry 520. Using the feedback, null inputs 510 can be updated such that null can reduce interference in the far field pattern generated by antenna elements.

FIG. 5B illustrates the interference feedback the terminal system received based on a generated pattern. Referring to FIG. 5B, an interference is identified in the far field pattern that was generated based on pattern 530 and was fed back as interference feedback 550 to the inputs to the system. Based on those new null inputs 510 created while maintaining main beam inputs 510, the system can generate a new far field pattern with nulls that are better directed at reducing the interference. In other words, the system can generate a far field pattern with one or more nulls and determine if there is a greater or desired reduction in interference that has been achieved to the main beam(s) used for transmitting and/or receive and based on that determination adjust the locations of one or more nulls.

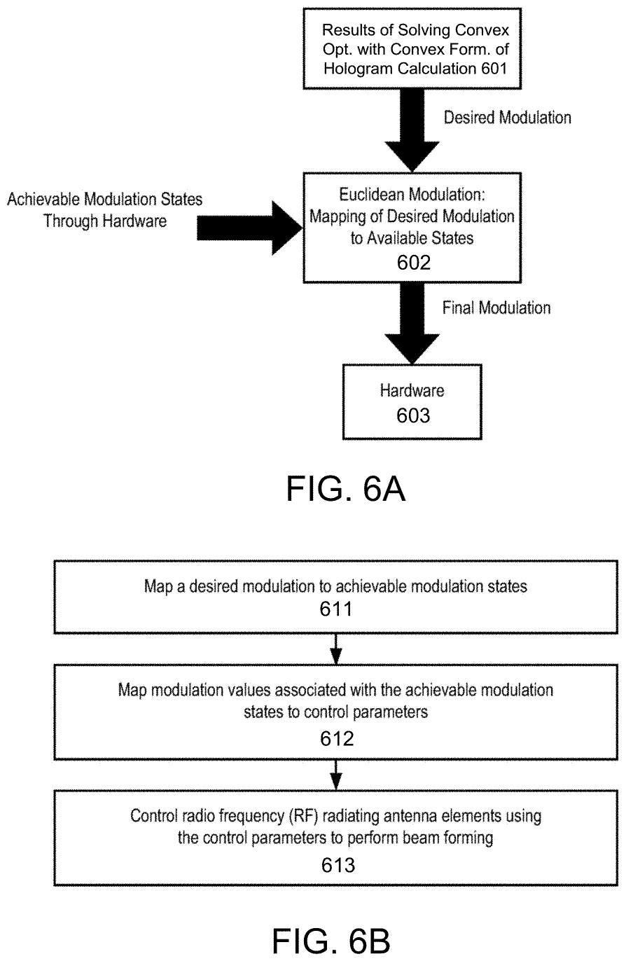

FIG. 6A is a data flow diagram of one embodiment of a process for controlling an antenna. In one embodiment, the antenna comprises a metasurface antenna having a plurality of surface scattering antenna elements. Example embodiments of such an antenna are discussed in more detail below. The process is performed by processing logic that may comprise hardware, software, firmware, or a combination of the three. In one embodiment, the processing logic is part of a modem of the antenna.

Referring to FIG. 6A, the process begins with processing logic solving the complex optimization problem using the convex formulation of a hologram equation, including performing a hologram calculation (processing block 601). In one embodiment, the inputs for the hologram calculation include the wave propagation in the feed, the location of the radiating cells, the beam pointing direction and the polarization. The result of the hologram calculation is the desired modulation.

Processing logic compares the desired modulation with the achievable modulation states and uses them to perform a Euclidean modulation module (processing block 602). As discussed herein, the Euclidean modulation module maps the desired modulation to the available, or achievable, states. In one embodiment, the mapping of the desired modulation to the available states includes creating a resonator model, extracting complex impedance values, and then mapping the complex desired modulation values to those impedance values based on Euclidean distance. In one embodiment, the achievable states are calculated using an ideal Lorentzian approximation for the magnetic dipole. In an alternative embodiment, a more realistic model of the resonator is generated.

The result of processing logic performing the Euclidean modulation module is the final modulation. Processing logic provides the final modulation to the antenna hardware to control the antenna to perform beamforming (processing block 603). In one embodiment, performing the beamforming with the antenna hardware using the final modulation includes mapping the final modulation values to control parameters (etc., control voltages to control, for example, the TFTs, diode current if using varactor diodes to control element capacitance, etc.) and controlling RF radiating antenna element unit cells (e.g., surface scattering antenna elements) to achieve the desired beamforming. In one embodiment, a control board receives the modulation values as input and generates outputs that drive the row and column lines of the TFT array

FIG. 6B is a flow diagram of one embodiment of a modulation process for controlling an antenna. The process is performed by processing logic that may comprise hardware, software, firmware, or a combination of the three. Referring to FIG. 6B, the process begins by mapping a desired modulation to achievable modulation states (processing block 611). In one embodiment, the desired modulation is obtained based on location of at least a subset of the RF radiating antenna elements, beam pointing direction and polarization, as well as the wave propagation in a feed of the antenna.

In one embodiment, the mapping a desired modulation to achievable modulation states is based on Euclidian distance. In one embodiment, the RF radiating antenna elements comprise tunable elements in a metasurface and mapping the desired modulation to achievable modulation states comprises approximating a set of required polarizabilities with a set of the tunable elements in the metasurface.

In one embodiment, mapping the desired modulation to achievable modulation states comprises selecting points out of achievable polarizabilities that approximate required polarizabilities of the desired modulation. In one embodiment, selecting points out of a set of achievable polarizabilities that approximate required polarizabilities of the desired modulation comprises minimizing distance between the required and achievable polarizabilities. In one embodiment, minimizing distance between the required and achievable polarizabilities comprises minimizing a Euclidean norm between the required and achievable polarizabilities.

After mapping a desired modulation to achievable modulation states, processing logic maps modulation values associated with the achievable modulation states to one or more control parameters (processing block 612). In one embodiment, the one or more control parameters comprise a voltage to be applied to each of the RF radiating antenna elements.

Using the control parameters, processing logic controls radio frequency (RF) radiating antenna elements of a metasurface (e.g., a metasurface antenna with surface scattering antenna elements such as described, for example, in more detail below) to perform beam forming (processing block 613).

In one embodiment, Euclidean modulation is implemented for a metamaterial antenna using the following algorithm:
1) Find the range of polarizabilities available for the metamaterial elements, given the tuning range of the elements.
2) For each metamaterial element in the waveguide, compute the ideal polarizability.
3) For each element, find the point on the range of available polarizabilities that is the shortest distance in the complex plane from the ideal polarizability.
4) Tune each element so that it operates with the polarizability that was found in step 3.

For more information on Euclidean modulation and the use of Euclidean mapping, see U.S. Pat. No. 10,686,636, entitled “Restricted Euclidean Modulation”, issued Jun. 16, 2020, and U.S. Pat. No. 11,018,912, entitled “Restricted Euclidean Modulation”, issued May 25, 2021.

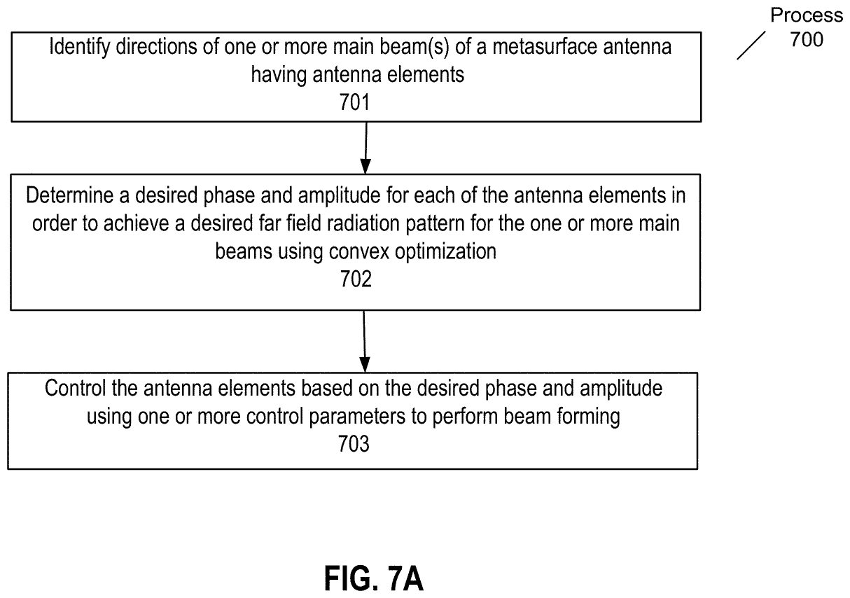

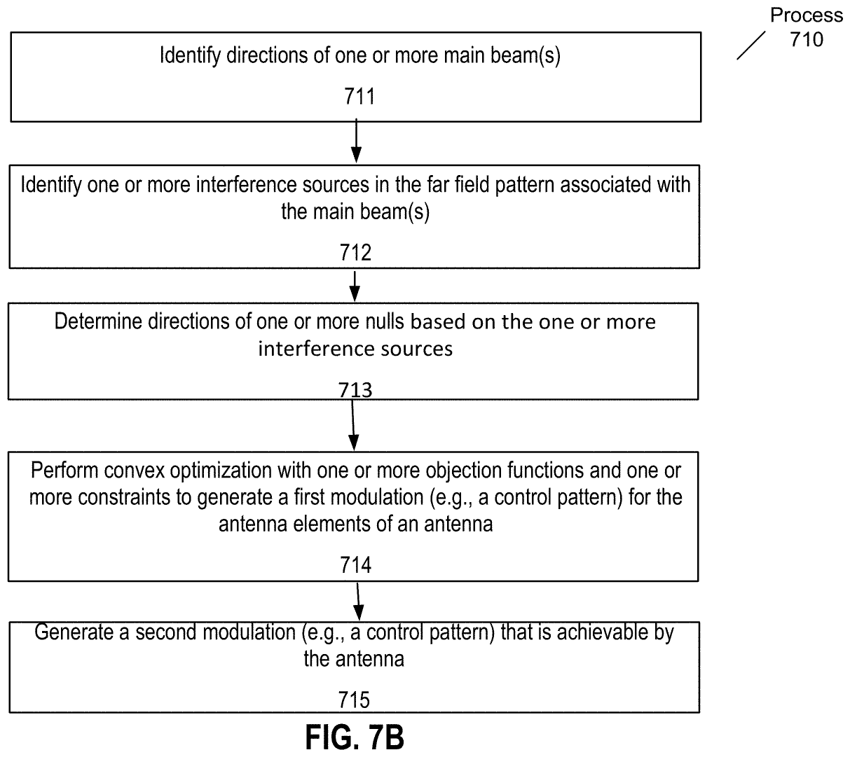

FIG. 7A is a flow diagram of some embodiments of a process 700 for controlling an antenna. In some embodiments, the process 700 is performed by a processing logic that may comprise hardware (circuitry, dedicated logic, etc.), software (e.g., software running on a chip), firmware, or a combination thereof or all three.

Referring to FIG. 7A, the process begins by identifying directions of one or more main beam(s) of a metasurface antenna having antenna elements (processing block 701). In some embodiments, the antenna elements are RF radiating antenna elements of a metasurface antenna. In some embodiments, the metasurface antenna comprises an antenna such as those described above. In some other embodiments, the metasurface antenna comprises a reflective metasurface.

After identifying directions of one or more main beams, processing logic determines a desired phase and amplitude for each of the antenna elements to achieve a desired far field radiation pattern for the one or more main beams using convex optimization (processing block 702). With the directions of the main beam(s), processing logic performs convex optimization with one or more objection functions and one or more constraints to generate a first a set of phase and amplitude values (e.g., a control pattern) for the antenna elements of an antenna.

In some embodiments, the desired far field radiation pattern includes one or more nulls at one or more specific directions, respectively, in the desired far field radiation patterns. In some embodiments, these nulls are to reduce effects of interference caused by signals from one or more satellites that are not in communication with the antenna. In some embodiments, the desired far field radiation pattern is for beam forming with linear or circular polarization. In some embodiments, determining the desired phase and amplitude for each of the antenna elements comprises solving the convex optimization problem using cross polarization and co-polarization matrices.

In some embodiments, determining the desired phase and amplitude for each of the antenna elements comprises defining theta and phi directions corresponding to an input wave; creating matrices for the co-polarization and cross polarization components for a desired polarization; and minimizing a target with respect to the cross polarization matrix subject to a constraint involving the co-polarization matrix.

In some embodiments, processing logic solves the convex optimization problem for single beam, scanned off, single null that achieves high cross polarization in the scan conditions using the following:

target=|w·Mxpol|² (optimizing cross polarization required for scan condition)

subject to following constraints:

w·Mcopol=[1,0] (main beam constraint)

|wi(n)²+wr(n)²|≤1 for each antenna element n

|w·Mnull|²≤λ (null constraint).

In some embodiments, processing logic solves the convex optimization problem to achieve a single beam, single null that achieves high cross polarization in the scan conditions with a modification of the magnitude and phase constraint to match metasurface radiator properties using the following:

target=|w·Mxpol|² (optimizing cross polarization required for scan condition)

subject to following constraints:

w·Mcopol=[1,0] (main beam constraint)

|(wi(n)−a)²+(wr(n)−b)²|≤1 for each antenna element n

(element magnitude, phase conditions can be shifted away from the center of circle to better match metasurface)

|w·Mnull|²≤λ (null constraint).

In some embodiments, processing logic solves the convex optimization problem to achieve a single beam and multiple nulls using the following:

target=|w·Mxpol|² (optimizing cross polarization required for scan condition)

subject to following constraints:

w·Mcopol=[1,0] (main beam constraint)

|wi(n)²+wr(n)²|≤1 for each antenna element n

|w·Mnull|²≤λ1

|w·Mnull2|²≤λ2

|w·Mnulln|2≤λn
(multi-null constraint).

In some embodiments, processing logic solves the convex optimization problem to achieve multiple main beams and a single null.

target=|w·Mxpol1|²λ1+|w·Mxpol2|²λ2
(optimizing cross polarization required for multi-beam scan condition)
   subject to following constraints:

w·Mcopol1=[1,0]

w·Mcopol2=[1,0]
(multi-beam constraint)

|wi(n)²+wr(n)²|≤1 for each antenna element n

|w·Mnull|²≤λ (null constraint).

In some embodiments, processing logic solves the convex optimization problem to achieve instantaneous bandwidth that is set by the user, while achieving peak gain. Note that both frequency domain and far field pattern properties can be optimized simultaneously.

target=w·Mcopol (f0) (optimizing far field pattern in frequency domain)

subject to following constraints:

w·Mcopol(f1)>λ

w·Mcopol(f2)>λ

w·Mcopol(f3)>λ
(constraining far field pattern over set of frequencies to achieve bandwidth characteristic)

|wi(n)₂+wr(n)²|≤1 for each antenna element n

Thereafter, processing logic controls the antenna elements based on the desired phase and amplitude using one or more control parameters to perform beam forming (processing block 703). In some embodiments, the one or more control parameters comprise a voltage to be applied to each of the antenna elements.

FIG. 7B is a flow diagram of some embodiments of a process 710 for controlling an antenna. In some embodiments, the process 710 is performed by a processing logic that may comprise hardware (circuitry, dedicated logic, etc.), software (e.g., software running on a chip), firmware, or a combination thereof or all three.

Referring to FIG. 7B, the process begins by identifying directions of one or more main beam(s) (processing block 711) and one or more interference sources in the far field pattern associated with the main beam(s) (processing block 712). Based on the interference sources, processing logic determines directions of one or more nulls (processing block 713).

With the directions of the main beam(s) and the null(s), processing logic performs convex optimization with one or more objection functions and one or more constraints to generate a first modulation (e.g., a control pattern) for the antenna elements of an antenna (processing block 714). In some embodiments, this modulation corresponds to phase and amplitude values for each of the antenna elements of the antenna. In some embodiments, the antenna elements are RF radiating antenna elements of a metasurface antenna. In some embodiments, the metasurface antenna comprises an antenna such as those described above. In some other embodiments, the metasurface antenna comprises a reflective metasurface. In some embodiments, the first modulation is a desired modulation that may or may not be achievable by the antenna.

If the first modulation is not achievable, processing logic generates a second modulation (e.g., a control pattern) that is achievable by the antenna (processing block 715).

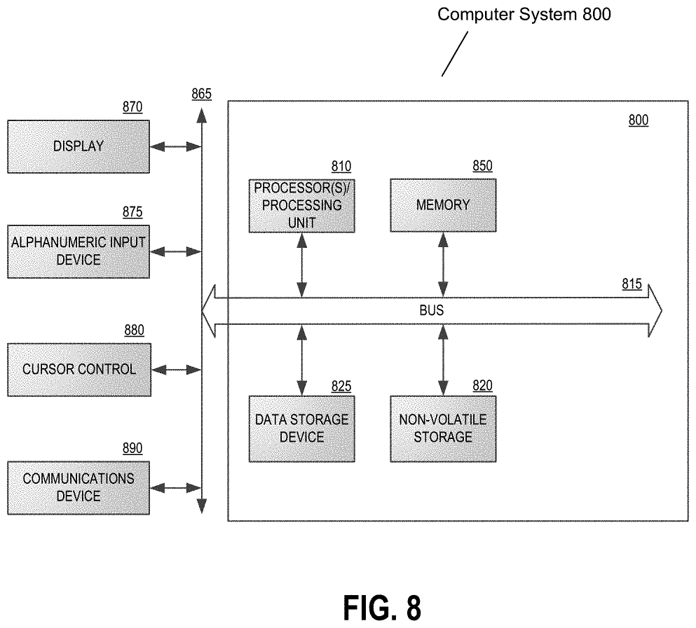

FIG. 8 is one embodiment of a computer system that may be used to support the systems and operations discussed herein, including performance of a convex optimization solver for solving the convex optimization problem. It will be apparent to those of ordinary skill in the art, however that other alternative systems of various system architectures may also be used.

The data processing system illustrated in FIG. 8 includes a bus or other internal communication means 815 for communicating information, and one or more processor(s) 810 coupled to the bus 815 for processing information. The system further includes a random-access memory (RAM) or other volatile storage device 850 (referred to as memory), coupled to bus 815 for storing information and instructions to be executed by processor(s) 810. Main memory 850 also may be used for storing temporary variables or other intermediate information during execution of instructions by processor(s) 810. The system also includes a read only memory (ROM) and/or static storage device 820 coupled to bus 815 for storing static information and instructions for processor(s) 810, and a data storage device 825 such as a magnetic disk or optical disk and its corresponding disk drive. Data storage device 825 is coupled to bus 815 for storing information and instructions.

The system may further be coupled to a display device 870, such as a light emitting diode (LED) display or a liquid crystal display (LCD), coupled to bus 815 through bus 865 for displaying information to a computer user. An alphanumeric input device 875, including alphanumeric and other keys, may also be coupled to bus 815 through bus 865 for communicating information and command selections to processor(s) 810. An additional user input device is cursor control device 880, such as a touchpad, mouse, a trackball, stylus, or cursor direction keys coupled to bus 815 through bus 865 for communicating direction information and command selections to processor 810, and for controlling cursor movement on display device 870.

Another device, which may optionally be coupled to computer system 800, is a communication device 890 for accessing other nodes of a distributed system via a network. The communication device 890 may include any of several commercially available networking peripheral devices such as those used for coupling to an Ethernet, token ring, Internet, or wide area network. The communication device 890 may further be a null-modem connection, or any other mechanism that provides connectivity between the computer system 800 and the outside world. Note that any or all the components of this system illustrated in FIG. 8 and associated hardware may be used in various embodiments as discussed herein.

It will be apparent to those of ordinary skill in the art that the system, method, and process described herein can be implemented as software stored in main memory or read only memory and executed by processor. This control logic or software may also be resident on an article of manufacture comprising a non-transitory computer readable medium having computer readable program code embodied therein and being readable by the mass storage device and for causing the processor to operate in accordance with the methods and teachings herein.

The embodiments discussed herein may also be embodied in a special purpose appliance including a subset of the computer hardware components described above. For example, the appliance may include a processor, a data storage device, a bus, and memory, and only rudimentary communications mechanisms.

There are a number of example embodiments described herein.

Example 1 is a method for controlling a metasurface antenna having antenna elements comprising: determining a desired phase and amplitude for each of the antenna elements to achieve a desired far field radiation pattern using convex optimization; and controlling radio frequency (RF) radiating antenna elements based on the desired phase and amplitude using one or more control parameters to perform beam forming.

Example 2 is the method of example 1 that may optionally include that the desired far field radiation pattern includes one or more nulls at one or more specific directions, respectively, in the desired far field radiation patterns.

Example 3 is the method of example 2 that may optionally include that at least one of the one or more nulls is to reduce effects of interference caused by signals from one or more satellites that are not in communication with the antenna.

Example 4 is the method of example 1 that may optionally include that the desired far field radiation pattern is for beam forming with linear or circular polarization.

Example 5 is the method of example 4 that may optionally include that determining the desired phase and amplitude for each of the antenna elements comprises solving the convex optimization problem using cross polarization and co-polarization matrices.

Example 6 is the method of example 4 that may optionally include that determining the desired phase and amplitude for each of the antenna elements comprises defining theta and phi directions corresponding to an input wave; creating matrices for the co-polarization and cross polarization components for a desired polarization; and minimizing a target with respect to the cross polarization matrix subject to a constraint involving the co-polarization matrix.

Example 7 is the method of example 1 that may optionally include that the one or more control parameters comprise a voltage to be applied to each of the antenna elements.

Example 8 is the method of example 1 that may optionally include selecting an achievable modulation state based on a Euclidean distance from a desired modulation state, wherein selecting the achievable modulation state includes mapping the achievable modulation state to voltages applied to the antenna elements, wherein the achievable modulation state corresponds to voltages applied to the antenna elements of the antenna to induce magnetic dipole moments; and mapping modulation values associated with the achievable modulation state to the one or more control parameters

Example 9 is the method of example 8 that may optionally include that mapping a desired modulation to achievable modulation states is based on Euclidian distance.

Example 10 is an antenna comprising: a metasurface having a plurality of RF radiating antenna elements; a controller coupled to the metasurface and having modulation logic to determine a desired phase and amplitude for each of the antenna elements to achieve a desired far field radiation pattern using convex optimization; and drive circuitry coupled to the metasurface and the controller to control the RF radiating antenna elements based on the desired phase and amplitude using one or more control parameters to perform beam forming.

Example 11 is the antenna of example 10 that may optionally include that the desired far field radiation pattern includes one or more nulls at one or more specific directions, respectively, in the desired far field radiation patterns.

Example 12 is the antenna of example 11 that may optionally include that at least one of the one or more nulls is to reduce effects of interference caused by signals from one or more satellites that are not in communication with the antenna.

Example 13 is the antenna of example 11 that may optionally include that the desired far field radiation pattern is for beam forming with linear or circular polarization.

Example 14 is the antenna of example 10 that may optionally include that the controller is configured to determine the desired phase and amplitude for each of the antenna elements by solving the convex optimization problem using cross polarization and co-polarization matrices.

Example 15 is the antenna of example 14 that may optionally include that the controller is configured to determine the desired modulation for each of the antenna elements by: defining theta and phi directions corresponding to an input wave; creating matrices for the co-polarization and cross polarization components for a desired polarization; and minimizing a target with respect to the cross polarization matrix subject to a constraint involving the co-polarization matrix.

Example 16 is the antenna of example 10 that may optionally include that the one or more control parameters comprise a voltage to be applied to each of the RF radiating antenna elements.

Example 17 is the antenna of example 10 that may optionally include that the controller is operable to: select an achievable modulation state based on a Euclidean distance from a desired modulation state, wherein selecting the achievable modulation state includes mapping the achievable modulation state to voltages applied to the antenna elements, wherein the achievable modulation state corresponds to voltages applied to the antenna elements of the antenna to induce magnetic dipole moments; and map modulation values associated with the achievable modulation state to the one or more control parameters

Example 18 is the antenna of example 17 that may optionally include that mapping a desired modulation to achievable modulation states is based on Euclidian distance.

Example 19 is one or more non-transitory computer readable storage media having instructions stored thereupon which, when executed by a system having at least a processor and a memory therein, cause the system to perform operations for controlling an antenna having antenna elements, the method comprising: determining a desired phase and amplitude for each of the antenna elements to achieve a desired far field radiation pattern using convex optimization; and controlling radio frequency (RF) radiating antenna elements based on the desired modulation using one or more control parameters to perform beam forming.

Example 20 is the one or more non-transitory computer readable storage media of example 19 that may optionally include that the desired far field radiation pattern includes one or more nulls at one or more specific directions, respectively, in the desired far field radiation patterns

Example 21 is the one or more non-transitory computer readable storage media of example 20 that may optionally include that at least one of the one or more nulls is to reduce effects of interference caused by signals from one or more satellites that are not in communication with the antenna.

Example 22 is the one or more non-transitory computer readable storage media of example 20 that may optionally include that the desired far field radiation pattern is for beam forming with linear or circular polarization.

Example 23 is the one or more non-transitory computer readable storage media of example 19 that may optionally include that determining the desired phase and amplitude for each of the antenna elements comprises solving the convex optimization problem using cross polarization and co-polarization matrices.

Methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

We claim:

1. A method for controlling a metasurface antenna having antenna elements, the method comprising:
determining a desired phase and amplitude for each of the antenna elements to achieve a desired far field radiation pattern using convex optimization; and
controlling radio frequency (RF) radiating antenna elements based on the desired phase and amplitude using one or more control parameters to perform beam forming.

2. The method of claim 1 wherein the desired far field radiation pattern includes one or more nulls at one or more specific directions, respectively, in the desired far field radiation patterns.

3. The method of claim 2 wherein at least one of the one or more nulls is to reduce effects of interference caused by signals from one or more satellites that are not in communication with the antenna.

4. The method of claim 1 wherein the desired far field radiation pattern is for beam forming with linear or circular polarization.

5. The method of claim 1 wherein determining the desired phase and amplitude for each of the antenna elements comprises solving the convex optimization problem using cross polarization and co-polarization matrices.

6. The method of claim 4 wherein determining the desired phase and amplitude for each of the antenna elements comprises:
defining theta and phi directions corresponding to an input wave;
creating matrices for the co-polarization and cross polarization components for a desired polarization; and
minimizing a target with respect to the cross polarization matrix subject to a constraint involving the co-polarization matrix.

7. The method of claim 1 wherein the one or more control parameters comprise a voltage to be applied to each of the antenna elements.

8. The method of claim 1 further comprising
selecting an achievable modulation state based on a Euclidean distance from a desired modulation state, wherein selecting the achievable modulation state includes mapping the achievable modulation state to voltages applied to the antenna elements, wherein the achievable modulation state corresponds to voltages applied to the antenna elements of the antenna to induce magnetic dipole moments; and
mapping modulation values associated with the achievable modulation state to the one or more control parameters

9. The method defined in claim 8 wherein mapping a desired modulation to achievable modulation states is based on Euclidian distance.

10. An antenna comprising:
a metasurface having a plurality of RF radiating antenna elements;
a controller coupled to the metasurface and having modulation logic to determine a desired phase and amplitude for each of the antenna elements to achieve a desired far field radiation pattern using convex optimization; and
drive circuitry coupled to the metasurface and the controller to control the RF radiating antenna elements based on the desired phase and amplitude using one or more control parameters to perform beam forming.

11. The antenna of claim 10 wherein the desired far field radiation pattern includes one or more nulls at one or more specific directions, respectively, in the desired far field radiation patterns.

12. The antenna of claim 11 wherein at least one of the one or more nulls is to reduce effects of interference caused by signals from one or more satellites that are not in communication with the antenna.

13. The antenna of claim 11 wherein the desired far field radiation pattern is for beam forming with linear or circular polarization.

14. The antenna of claim 11 wherein the controller is configured to determine the desired phase and amplitude for each of the antenna elements by solving the convex optimization problem using cross polarization and co-polarization matrices.

15. The antenna of claim 14 wherein the controller is configured to determine the desired modulation for each of the antenna elements by:
defining theta and phi directions corresponding to an input wave;
creating matrices for the co-polarization and cross polarization components for a desired polarization; and
minimizing a target with respect to the cross polarization matrix subject to a constraint involving the co-polarization matrix.

16. The antenna of claim 10 wherein the one or more control parameters comprise a voltage to be applied to each of the RF radiating antenna elements.

17. The antenna of claim 10 wherein the controller is operable to:
select an achievable modulation state based on a Euclidean distance from a desired modulation state, wherein selecting the achievable modulation state includes mapping the achievable modulation state to voltages applied to the antenna elements, wherein the achievable modulation state corresponds to voltages applied to the antenna elements of the antenna to induce magnetic dipole moments; and
map modulation values associated with the achievable modulation state to the one or more control parameters

18. The antenna defined in claim 17 wherein mapping a desired modulation to achievable modulation states is based on Euclidian distance.

19. One or more non-transitory computer readable storage media having instructions stored thereupon which, when executed by a system having at least a processor and a memory therein, cause the system to perform operations for controlling an antenna having antenna elements, the method comprising:
determining a desired phase and amplitude for each of the antenna elements to achieve a desired far field radiation pattern using convex optimization; and
controlling radio frequency (RF) radiating antenna elements based on the desired modulation using one or more control parameters to perform beam forming.

20. The one or more non-transitory computer readable storage media of claim 19 wherein the desired far field radiation pattern includes one or more nulls at one or more specific directions, respectively, in the desired far field radiation patterns

21. The one or more non-transitory computer readable storage media of claim 20 wherein at least one of the one or more nulls is to reduce effects of interference caused by signals from one or more satellites that are not in communication with the antenna.

22. The one or more non-transitory computer readable storage media of claim 20 wherein the desired far field radiation pattern is for beam forming with linear or circular polarization.

23. The one or more non-transitory computer readable storage media of claim 19 wherein determining the desired phase and amplitude for each of the antenna elements comprises solving the convex optimization problem using cross polarization and co-polarization matrices.
